(19) United States
(12) Patent Application Publication
(10) Pub. No.: US 2026/0136026 A1
(43) Pub. Date: May 14, 2026

(54) PROBABILITY MODEL INITIALIZATION USING PROBABILITY MODELS FROM A REFERENCE FRAME

(71) Applicant: GOOGLE LLC, Mountain View, CA (US)

(72) Inventors: Lin Zheng, Waterloo (CA); Jingning Han, Santa Clara, CA (US); Yaowu Xu, Saratoga, CA (US)

(21) Appl. No.: 19/384,185

(22) Filed: Nov. 10, 2025

Related U.S. Application Data
(60) Provisional application No. 63/719,067, filed on Nov. 11, 2024.

(51) Int. Cl. H04N 19/196; H04N 19/132; H04N 19/172; H04N 19/423

(52) U.S. Cl. CPC H04N 19/197; H04N 19/132; H04N 19/172; H04N 19/423

(57) ABSTRACT

Disclosed are techniques for initializing probability models in video coding. A single combined probability model for a current frame is generated based on a plurality of probability models determined for each tile of a subset of tiles in a reference frame, where the subset of tiles is fewer in number than a total number of tiles in the reference frame. For each tile of a plurality of tiles of the current frame, a respective probability model is initialized for the respective tile using the single combined probability model as an initial probability model.

### CROSS-REFERENCE TO RELATED APPLICATIONS

This disclosure claims the benefit of U.S. Provisional Patent Application No. 63/719,067 filed November 11, 2024, the disclosure of which is incorporated by reference herein in its entirety.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to probability model initialization using probability models from a reference frame.

In some aspects, a method is provided. The method includes generating a single combined probability model for a current frame based on a plurality of probability models including probability models respectively determined for each tile of a subset of tiles in a reference frame, the subset of tiles being fewer in number than a total number of tiles in the reference frame. The method further includes, for each current tile of a plurality of tiles of the current frame, initializing a respective probability model for the current tile using the single combined probability model as an initial probability model.

In some aspects, a device for decoding a video stream is provided. The device includes a memory and a processor configured to execute instructions stored in the memory to generate a single combined probability model for a current frame based on a plurality of probability models including probability models respectively determined for each tile of a subset of tiles in a reference frame, the subset of tiles being fewer than a total number of tiles in the reference frame. The processor is further configured to, for each current tile of a plurality of tiles of the current frame, initialize a respective probability model for the current tile using the single combined probability model as an initial probability model.

In some aspects, a non-transitory computer-readable storage medium is provided having stored thereon an encoded video bitstream. The encoded video bitstream is decodable by a decoder configured to generate a single combined probability model for a current frame based on a plurality of probability models including probability models respectively determined for each tile of a subset of tiles in a reference frame, the subset of tiles being fewer than a total number of tiles in the reference frame. The decoder is further configured to, for each current tile of a plurality of tiles of the current frame, initialize a respective probability model for the current tile using the single combined probability model as an initial probability model.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a flowchart describing techniques for probability initialization.

FIG. 7 is a block diagram illustrating a first storage configuration for caching and saving probability models and an associated data flow.

FIG. 8 is a flowchart describing a technique for probability model initialization using probability models from a reference frame.

FIG. 9 is a flowchart describing a technique for generating a single combined probability model and initializing probability models for tiles in a current frame.

### DETAILED DESCRIPTION

As mentioned above, compression schemes related to coding video streams may include breaking images (i.e., original or source images) into blocks and generating a digital video output bitstream using one or more techniques to limit the information included in the output. A received encoded bitstream can be decoded to re-create the blocks and the source images from the limited information. A video stream may be encoded using a variety of tools resulting in a variety of syntax elements which are stored in a compressed bitstream to enable the transfer of the encoded information between an encoder and a decoder. These syntax elements may be encoded in the compressed bitstream using lossless encoding.

One type of lossless coding is called entropy coding. Entropy is generally considered the degree of disorder or randomness in a system. Entropy coding is designed to compress a sequence (e.g., including bits representing a syntax element) in an informationally efficient way. A lower bound of the length of the compressed sequence is the entropy of the original sequence. An efficient algorithm for entropy coding aims to generate a code (e.g., in bits) whose length approaches this entropy. For a particular sequence of syntax elements, the entropy associated with the code may be measured as a function of the probability distribution(s) of observations (e.g., symbols, values, outcomes, hypotheses, etc.) for the syntax elements over the sequence. In some implementations, separate probability distributions may be measured for different syntax elements in order to obtain a more compact set of probability distributions. Arithmetic coding, for example, can use a measured probability distribution to construct a code used to encode the sequence.

A codec may not receive an encoded bitstream together with its actual probability distribution(s). Instead, probability estimation may be used in video codecs to implement entropy coding. The probability distribution(s) for an encoded bitstream (e.g., for a frame or a tile in the encoded bitstream) may be estimated using one or more probability models that model the probability distribution occurring in an encoded bitstream. A probability model can include multiple sets of probabilities each representing, for example, a probability distribution for a particular syntax element or syntax elements. A probability model can include multiple sets of probabilities for a particular syntax element, where the set of probabilities utilized may depend on a context of previously encoded or decoded information. The probability models are ideally designed so that the estimated probability distribution approaches the actual probability distribution. Using these techniques, entropy coding can reduce the number of bits required to represent the input data to close to a theoretical minimum (i.e., the lower bound). The probability models may be expressed or given by various mathematical functions, including a probability mass function (PMF) or Cumulative Distribution Functions (CDFs).

Generally, a probability model (e.g., including a set of CDFs) is initialized at the start of a frame or tile to be encoded or decoded. The initialization, for example, may be performed using sets of default probabilities (e.g., where no previously computed probability models are available). The initialization may also be performed by utilizing a probability model from a prior frame, such as a largest tile in a prior frame, to initialize the probability model for the current frame (e.g., which may include the probability models used for all tiles within the current frame). As symbols (e.g., corresponding to particular syntax elements) are encountered during encoding or decoding, the initialized probability model is updated according to the actual data encountered during encoding or decoding. For example, after each encoded or decoded symbol, the set of probabilities that applies to the prior symbol may be updated based on the observation of an additional example of a particular symbol (e.g., the probability of the occurrence of that symbol may be increased). This process repeats (using the same procedure at encoded and decoder) until the end of the frame or tile. The resulting probability model (once the frame or tile is encoded/decoded) is likely more accurate than the initialized probability model because of the observations made during encoding/decoding and the updates that were accordingly made to the probability model. Typically, when tiles are utilized, each tile utilizes its own probability model which is updated separately in the course of encoding/decoding each such tile (because tiles, in many cases, may be encoded or decoded independently of each other).

One way of utilizing such a previously updated probability model would be to take a probability model from a largest tile (e.g., based on number of bits) from a prior frame and utilize that probability model to initialize the probability model for the current frame (e.g., which could be used for all tiles in the current frame). Problems with this approach include that the probability model for a particular tile does not represent the probability distribution of symbols across the entire frame, and different areas of a frame may have different content and thus different probability distributions. Accordingly, the use of a single pre-determined probability distribution may result in an initialized probability model that has an undesirable variance from the actual probability distribution of the current frame.

Another way of utilizing such a previously updated probability model would be to average the probability models of the tiles of a prior frame and to use the average probability model to initialize the probability model for the current frame (e.g., which could be used for all tiles in the current frame). Problems with this approach include storage requirements and limitations relating to storing the probability models for all tiles so that they can be averaged. For example, a frame may include a large number of tiles, which may require an equally large amount of memory set aside for probability models which may not be practical, for example, in a hardware encoder or decoder, where storage (e.g., SRAM) may be limited. Accordingly, the use of an average of the probability models for all tiles in a frame may not be practical in certain implementations. Therefore, a need exists for a technique that can generate a robust, generalized initial probability model for a frame without requiring excessive memory or computational resources, while also avoiding the statistical inaccuracies of using a model from a single portion of a prior frame.

Implementations according to this disclosure solve problems such as these including by initializing a probability model for a current frame based on probability models determined for a subset of tiles in a reference frame. The subset of tiles is a selection of tiles that is fewer than the total number of tiles in the reference frame. For example, as the decoding of tiles are completed in the reference frame, probability models from selected ones of the tiles may be cached (e.g., in SRAM). The caching of probability models may be selected, for example, by a common process used by both the encoder or decoder, or certain probability models may be cached by the encoder and the identification of the tiles from which the cached probability models were selected may then be included in the compressed bitstream so that the decoder is able to cache the same probability models when the compressed bitstream is decoded. The cached probability models may then be averaged or otherwise combined to generate a single combined probability model usable for initializing the probability model of a later frame. Where the later frame includes multiple tiles, the single combined probability model may be used to initialize the probability model for all tiles in the later frame.

For example, the combined probability model may be stored in a reference frame buffer along with the frame data of the reference frame. In some implementations, the combined probability model used to initialize the probability model for a current frame may be selected based on a reference frame identifier included in the compressed bitstream for the current frame that refers to a location in the reference frame buffer where the reference frame and associated probability model are stored.

In some implementations, instead of an average of the cached probability models, a weighted average may be used instead. For example, a number of probability updates may be tracked for the probability model in each tile, and the average of the cached probability models may be weighted according to the counts, in order to provide greater weighting to those probability models that have a larger number of probability updates (which may result in a more accurate probability model).

The number of cached probability models may be capped at a maximum number, which may be 2, 4, or 6 cached probability models. In some implementations, the probability models that are cached may be selected based on them being from the largest tile sizes (for example, if there are a maximum of 2 tiles and more than 2 tiles in the frame, the probability models from the tiles having the two largest sizes out of all the tiles will be cached), probability models having the largest numbers of probability updates (e.g., up to the maximum number of tiles referenced above), distribution of tiles in the frame (e.g., to provide a spatially representative sample), categorization of tiles in the frame, an image segmentation of the frame, other characteristic(s) of the tiles or probability models, or some combination thereof.

As used herein, a 'tile' refers to a spatially distinct, independently decodable region of a video frame, such as a rectangular group of blocks. A 'probability model' refers to a set of probability distributions (e.g., CDFs or PMFs) for various syntax elements used in entropy coding. A 'combined probability model' or ‘single combined probability model’ refers to a single, unified probability model that is generated by combining two or more individual probability models from different sources, such as probability models obtained by encoding or decoding multiple tiles in a reference frame. A tile in a current frame is considered 'co-located' with a tile in a reference frame if it occupies the same or substantially the same spatial position within the frame boundaries.

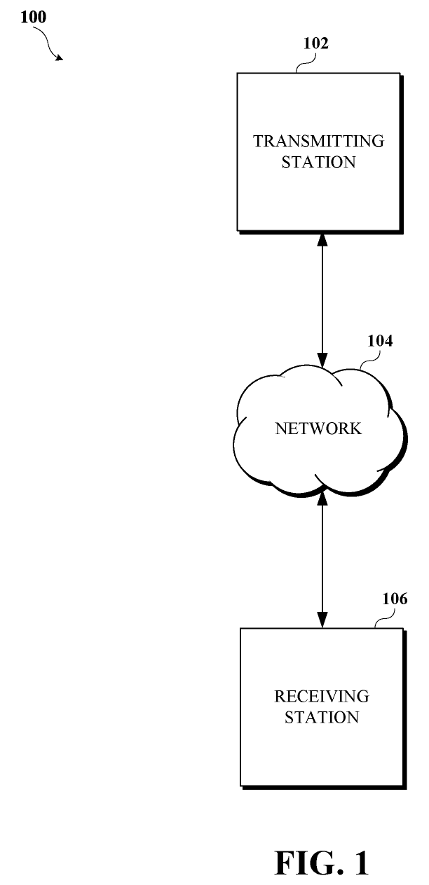

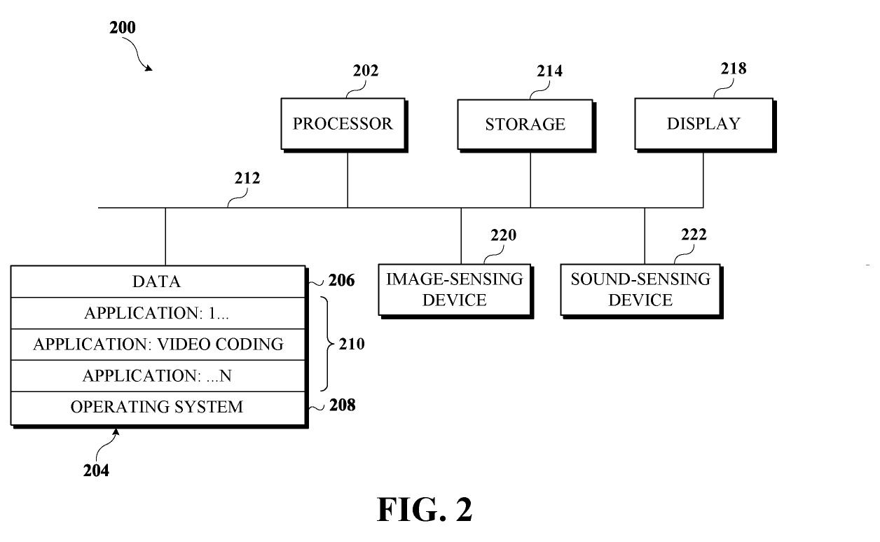

Further details of probability model initialization using probability models from a reference frame are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the techniques described here. For example, the application programs 210 can include applications 1 through N, which further include a video coding application that performs the techniques described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

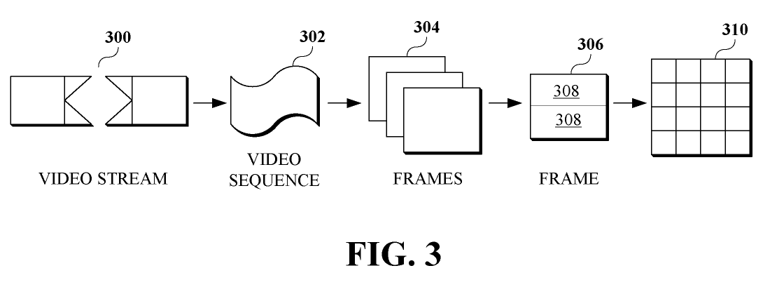

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 (e.g., which may also be referred to as tiles) can be subsets of frames that permit parallel processing, for example. The configuration of tiles in a frame may vary depending on the implementation, and may take the form of columns, rows, rectangular areas, or other collections of blocks, depending on the implementation. The use of tiles may be configured such that a tile does not have dependencies on or has limited dependencies on other tiles to permit tiles to be encoded and/or decoded independently of each other (e.g., within a frame, or a portion of a frame). The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16x16 pixels in the frame 306. The blocks 310 can also be arranged to include data from one or more segments 308 of pixel data. The blocks 310 can also be of any other suitable size such as 4x4 pixels, 8x8 pixels, 16x8 pixels, 8x16 pixels, 16x16 pixels, or larger. Unless otherwise noted, the terms block and macro-block are used interchangeably herein.

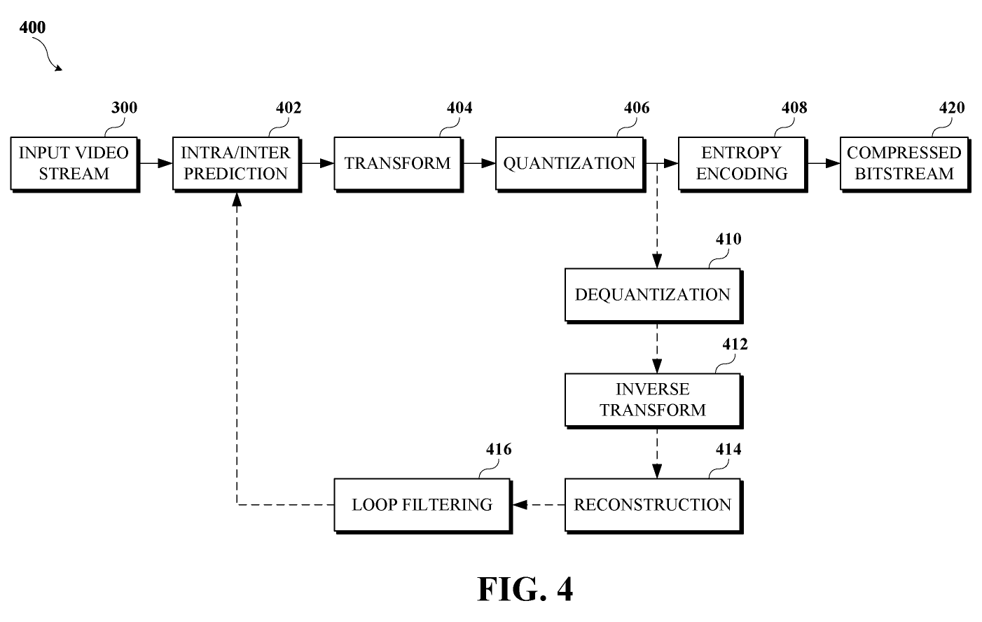

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, MVs and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

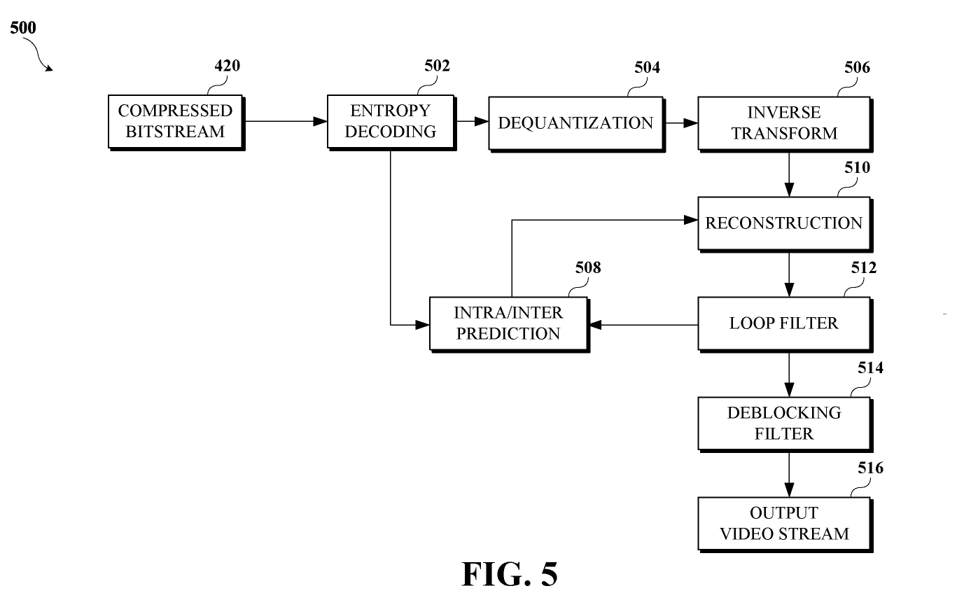

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients and other decoded syntax elements needed for the decoding process. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

As can be appreciated from the description of the encoder 400 and the decoder 500 above, bits are generally used for content prediction (e.g., inter mode/motion vector coding, intra prediction mode coding, etc.), residual or coefficient coding (e.g., transform coefficients), or other side information needed to decode the compressed bitstream. Encoders may use techniques to decrease the bits spent on representing this data. For example, a coefficient token tree (which may also be referred to as a binary token tree) may specify the scope of the value, with forward-adaptive probabilities for each branch in this token tree. The token base value is subtracted from the value to be coded to form a residual, then the block is coded using the probabilities applicable for that residual. A similar scheme with minor variations including backward-adaptivity is also possible. Adaptive techniques can alter the probability models as the video stream is being encoded to adapt to changing characteristics of the data. In any event, a decoder is informed of (or has available) the probability model used to encode an entropy-coded video bitstream so the decoder can decode the video bitstream.

That is, and as described initially above, a video codec may use arithmetic coding to effectuate the entropy coding of syntax elements (such as the data referenced above). The coding efficiency is dependent on the accuracy of the probability model used for the tiles and/or frames in the video bitstream. The probability model may be, for example, represented by a PMF or a CDF for each or groups of the various syntax elements in the bitstream. Additional PMFs or CDFs may be provided for a given syntax element(s) which may be selected depending on context. For example, a probability model may include a large number of CDFs each representative of the current probability distribution for a given syntax element / context combination.

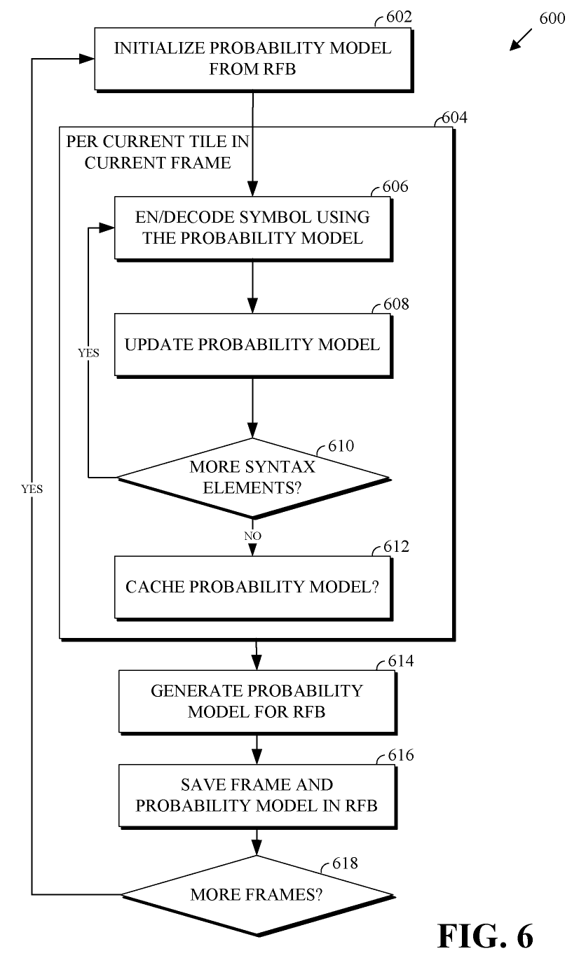

FIG. 6 is a flowchart describing techniques 600 for probability initialization. Techniques 600 may be performed by an encoder or decoder, such as encoder 400 using entropy encoding stage 408 or decoder 500 using entropy decoding stage 502.

At step 602, a probability model for a current frame is initialized from a probability model stored in a reference frame buffer (RFB). For example, a reference frame buffer may include storage for information about multiple reference frames (e.g., four or seven), and for each such reference frame, the decoded reference frame and a probability model for the reference frame may be stored. A syntax element may be included in a compressed bitstream identifying which reference frame to utilize for a current frame (e.g., in the case of a decoder) or the reference frame to utilize for a current frame may be determined (e.g., in the case of an encoder). The saved probability model corresponding to the identified or determined reference frame can be used to initialize the probability model for the current frame. In certain implementations, the same initialized probability model is used for all tiles in the current frame. That is, the single combined probability model generated based on probability models from the reference frame serves as a global initial state for the current frame, and is used to initialize the respective probability model used for each of the tiles in the current frame before they are individually processed.

At step 604, current tiles in the current frame are encoded or decoded (e.g., depending on whether techniques 600 are performed by an encoder or decoder) using steps 606-612. The group of steps 606-612 may be performed for each current tile concurrently, in parallel, or some combination thereof, depending on the implementation.

At step 606, a symbol is encoded or decoded using the probability model for the tile. The symbol is a value corresponding to a syntax element in a compressed bitstream. If no prior syntax elements have been encoded or decoded, the probability model is the same as the initialized probability model from step 602. If prior syntax elements have been encoded or decoded the probability model has been updated (perhaps many times) by step 608 and has changed according to the actual occurrences of symbols encoded or decoded for the current tile. For example, a syntax element may represent an x component of a motion vector and the symbol may indicate the value of the x component.

At step 608, the probability model is updated based on the occurrence of the symbol encoded or decoded at step 606. For example, a count of the symbol for the associated syntax element may be incremented and a set of probabilities for that syntax may be updated based on the updated count.

At step 610, if there are more syntax elements to be encoded or decoded for the current tile, control passes back to step 606 to encode or decode the next syntax element. If all syntax elements have been encoded or decoded, control passes to step 612.

At step 612, a determination is made as to whether to cache the probability model for the current tile. In some implementations, the determination is made by a technique common to both the encoder and decoder. For example, if a maximum of four probability models may be cached, the probability models from the four largest tiles may be cached or the four probability models having the largest number of probability updates may be cached. In another example, probability models may be cached based on tile location.

In some implementations, probability models may be cached along with an indication of the tile from which the probability model was cached or information needed to determine whether a probability model from a later encoded or decoded tile should be cached instead of the previously cached probability model. For example, the probability models for the first four tiles encoded or decoded for a current frame may be cached along with an indication of those tiles sizes. When step 612 is reached for the following encoded or decoded tiles, the size of those tiles may be compared to the size of the tiles from which the previously cached probability models were obtained. If the later tile is larger in size than the prior tiles from which the cached probability models were obtained, the probability model from the later tile may be cached instead of the previously cached probability model associated with the smallest tile.

Control passes to step 614 once step 604 is completed (e.g., all tiles have completed steps 606-612). At step 614, a probability model is generated that is stored in a reference frame buffer. For example, a combined probability model is generated from the cached probability models. The combined probability model may be generated, for example, by averaging or weighted averaging the cached probability models.

At step 616, the current frame and combined probability model is saved into a reference frame buffer. For example, if the reference frame buffer has room for multiple reference frames, the current frame buffer and combined probability model may be saved in a location identified by a number x, e.g., RFB[x]. In some implementations, the encoder may determine whether or where to store the current frame and combined probability model in the RFB and this determination may be included in the compressed bitstream so that the decoder may do the same. In the case where the reference frame is not stored in the reference frame buffer, steps 614 and 616 may be skipped for a given current frame.

At step 618, if there are more frames, control passes back to step 602 to initialize the probability model for the next frame.

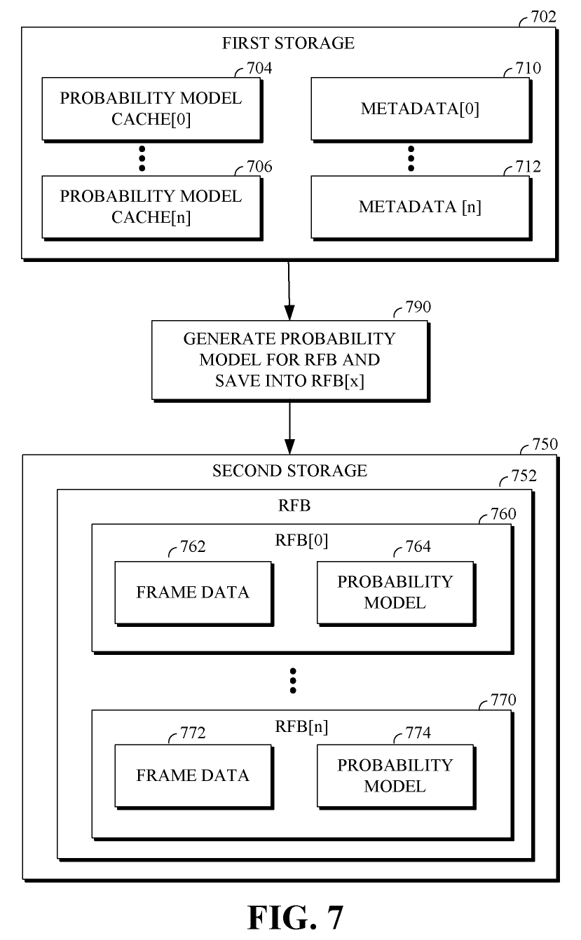

FIG. 7 is a block diagram illustrating a first storage configuration for caching and saving probability models and an associated data flow. FIG. 7 includes a first storage 702 and a second storage 750. First storage 702 may be implemented using a faster storage mechanism, such as SRAM on a hardware encoder or decoder. Second storage 750 may be implemented using a slower storage mechanism, such as DRAM connected to a hardware encoder or decoder.

First storage 702 may include multiple probability model cache storage areas 764, 766 (e.g., n storage areas as depicted) and multiple metadata storage areas 710, 712 (e.g., n storage areas as depicted). Probability model cache storage areas 764, 766 may be utilized to store cached probability models that, e.g., are cached at step 612 of FIG. 6. Metadata storage areas 710, 712 may be utilized to store additional information relating to the cached probability models that may be utilized by the encoder or decoder to determine how to cache probability models (e.g., such as the size of the tile, number of probability updates, or location of the tile from which the associated cached probability model is obtained). For example, the information in metadata[0] may correspond to the probability model in probability model cache[0]. In some implementations, metadata storage areas 710, 712 may be omitted or implemented differently, for example if identifications of the tiles to use for caching probability models are determined by the encoder and transmitted in the compressed bitstream.

Second storage 750 may include a reference frame buffer (RFB) that includes multiple storage areas 760,770 (e.g., as shown, n storage areas) for storing reference frame data such as frame data 762,772 and probability model 764,774. For example, one of the storage areas 760,770 may be used to store the frame data and combined probability model stored in step 616 of FIG. 6.

Data stored in first storage 702 may be accessed and utilized in order to execute technique 790 of generating probability model for RFB and saving the probability model into RFB[x] (e.g., one of storage areas 760, 770) which is in second storage 750. Technique 790 may, for example, correspond to steps 614 and 616 of FIG. 6. As previously described, generating the probability model (e.g., a combined probability model) may be performed using an average or weighted average of probability models. It is advantageous for the average, weighted average, or other combination of probability models to be performed using the cached probability models stored in first storage 702 because first storage 702 is implemented using memory with a faster access speed, such as SRAM (as compared to, for example, DRAM for second storage 750). By comparison, performing the combination using information stored in DRAM or other slower storage may disadvantageously increase the time required to perform the combination such that the encoding or decoding process will be delayed.

Different storage configurations are possible that vary from what is described with respect to FIG. 7. For example, probability models may be stored and identified separately from the reference frames or for only some reference frames. For example, metadata relating to the cached probability models may not be stored in the RFB and may be maintained elsewhere. Other variations may be utilized, depending on the implementation.

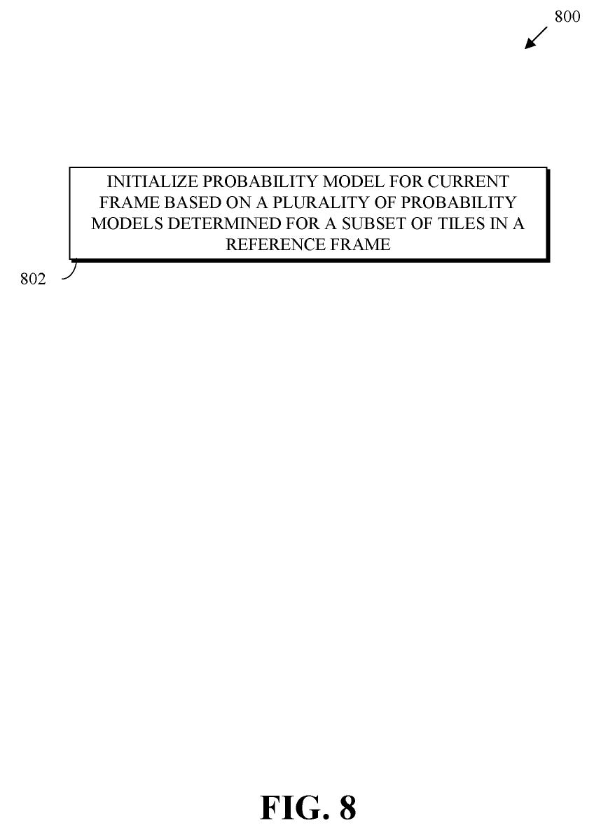

FIG. 8 is a flowchart describing a technique 800 for probability model initialization using probability models from a reference frame. Technique 800 may be performed by an encoder or decoder, such as encoder 400 using entropy encoding stage 408 or decoder 500 using entropy decoding stage 502.

Step 802 includes initializing a probability model for a current frame based on a plurality of probability models determined for a subset of tiles in a reference frame. For example, respective ones of the plurality of probability models may be obtained from respective ones of the subset of tiles in the reference frame. For example, the plurality of probability models includes a probability model from each of the subset of tiles. In some implementations, step 802 may be performed using techniques 600 described with respect to FIG. 6 or some variation thereof. In some implementations, step 802 may be performed using storage and/or data flows such as described previously with respect to FIG. 7.

The subset of tiles may be capped at a maximum number of tiles, such as 2, 4, or 6 tiles. For example, the number of tiles in the subset of tiles will not exceed the maximum number, even if a number of tiles in the relevant reference frame exceeds that maximum number. In such an event, only a portion of the tiles in the relevant reference frame will be included in the subset of tiles. For example, the subset of tiles may be restricted to a pre-determined maximum number of tiles not based on a number of tiles in the reference frame.

In some implementations, technique 800 includes caching the plurality of probability models determined for the subset of tiles in the reference frame. For example, probability models may be cached such as previously described with respect to FIGS. 6 and 7. In some implementations, technique 800 includes generating a combined probability model from the plurality of probability models. For example, a combined probability model may be generated such as described previously with respect to step 614 of FIG. 6. In some implementations, step 802 includes initializing the probability model for the current frame using the combined probability model.

In some implementations, generating the combined probability model includes averaging the plurality of probability models.

In some implementations, generating the combined probability model includes weighted averaging the plurality of probability models. For example, the plurality of probability models may each include a set of probabilities for a syntax element and a count of updates to the set of probabilities. The weighted averaging of the plurality of probability models may then include weighting based on the counts of updates to the sets of probabilities. For example, sets of probabilities having a higher count may be weighted more in the weighted average than sets of probabilities having a lower count. This may be repeated for the remaining sets of probabilities included in the probability models.

In some implementations, the weighting based on the counts of updates to the sets of probabilities is capped at a weighting maximum. For example, the weighting maximum may be set at 32 or 128. The weighting maximum can be used to avoid disproportionately weighting a tile with a substantial number of updates when prior updates have less weight than more recent updates. For example, this may apply in an implementation where the probability models determined for respective tiles in the reference frame are determined using a moving window with a forgetting factor.

In some implementations, the combined probability model is stored in a reference frame buffer and the combined probability model is selected for initializing the probability model for the current frame based on an identification of the reference frame buffer. For example, a reference frame buffer such as described with respect to FIG. 7 may be utilized.

In some implementations, the reference frame buffer is saved in DRAM and the plurality of probability models are cached in SRAM, for example, such as described with respect to first storage 702 and second storage 750 as described with respect to FIG. 7.

In some implementations, the subset of tiles is selected from tiles in the reference frame based on side information generated during encoding and decoded from a compressed bitstream. In some implementations, the subset of tiles is selected according to a pre-determined process used by both encoder and decoder. For example, the largest tiles from the reference frame may be included in the subset of tiles or the tiles from the reference frame are included in the subset of tiles based on tile location.

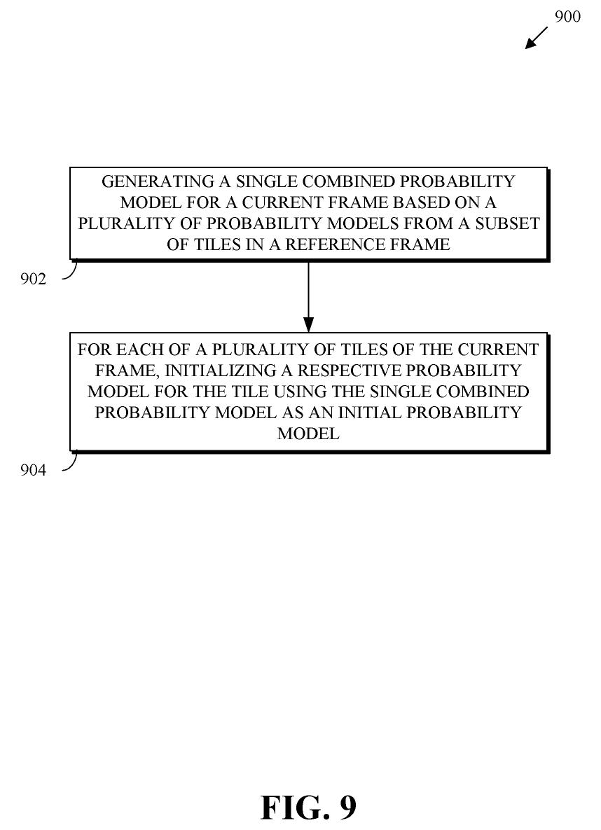

FIG. 9 is a flowchart describing a technique 900 for generating a single combined probability model and initializing probability models for tiles in a current frame. The technique 900 can be executed using computing devices, such as the systems, hardware, and software described with respect to FIGS. 1-8. For example, the technique 900 may be an example of an implementation of the technique 800 described with respect to FIG. 8. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

Step 902 includes generating a single combined probability model for a current frame based on a plurality of probability models including probability models respectively determined for each of a subset of tiles in a reference frame, the subset of tiles being fewer than a total number of tiles in the reference frame. The subset of tiles may be selected according to a pre-determined process used by both an encoder and a decoder. In some implementations, the subset of tiles is selected from tiles in the reference frame based on side information generated during encoding. For example, a tile from the reference frame may be included in the subset of tiles based on it having a largest tile size in the reference frame, or based on tile location. In some implementations, the selection of the subset of tiles is based on a number of probability updates. For example, a processor may be configured to select the subset of tiles from the reference frame based on a number of probability updates associated with each tile in the subset of tiles. This may facilitate choosing tiles that have undergone more adaptation and thus contain more statistically mature probability models. In some implementations, the subset of tiles is selected to provide a spatially representative sample of the reference frame. The subset of tiles may be restricted to a pre-determined maximum number of tiles not based on a number of tiles in the reference frame. For example, the subset of tiles may include a maximum of 2, 4, or 6 tiles. Generating the single combined probability model may include averaging the plurality of probability models. In some implementations, generating the single combined probability model includes weighted averaging the plurality of probability models. For example, the probability models of the plurality of probability models may each include a set of probabilities for a syntax element and a count of updates to the set of probabilities, and the weighted averaging of the plurality of probability models may include averaging the set of probabilities for the syntax element weighted based on the count of updates to the set of probabilities. In some implementations, the weighting based on the count of updates to the set of probabilities is capped at a weighting maximum. The single combined probability model may be stored in a reference frame buffer and the single combined probability model may be selected for initializing the probability model for the current frame based on an identification of the reference frame buffer. For example, the reference frame buffer may be saved in DRAM and the plurality of probability models may be cached in SRAM, as described with respect to FIG. 7.

In implementations where the subset of tiles is selected to provide a spatially representative sample of the reference frame, the selection process may be configured to choose tiles from different spatial regions of the frame. The purpose of such a selection may be to create a more balanced and generalized single combined probability model that is not unduly biased by the statistical properties of any single region of the reference frame, which might contain unique content (e.g., high motion, static texture, or flat areas).

For example, a pre-determined process, common to both an encoder and a decoder, may facilitate this selection by dividing the reference frame into a logical grid (e.g., quadrants) and selecting one or more tiles from each section of the grid. The tile selected from each section could be, for instance, the tile with the largest size or the tile associated with the greatest number of probability updates within that section. In another example, the process may be configured to select tiles at pre-defined locations, such as a tile from a corner, a tile from an edge, and a tile from the center of the frame. By sampling from various locations, the resulting single combined probability model can better reflect the overall statistical diversity of the entire reference frame. This can result in a more accurate initial state for the respective probability models of the current frame's tiles, potentially improving overall coding efficiency by reducing the number of bits needed to encode syntax elements at the beginning of each tile's processing.

Step 904 includes, for each of a plurality of tiles of the current frame, initializing a respective probability model for the respective tile using the single combined probability model as an initial probability model. For example, the plurality of tiles of the current frame may include a first tile and a second tile, where the first tile is co-located with a tile from the subset of tiles of the reference frame, and the second tile is not co-located with any tile from the subset of tiles of the reference frame. In such a case, the single combined probability model is used to initialize the respective probability model for both the first tile and the second tile.

Implementations of technique 900 provide an initial state for the entire current frame. Consequently, the initialization of a probability model for a given tile in the current frame may be independent of its specific spatial correspondence to any particular tile in the reference frame.

In some implementations, steps 902 and 904 of technique 900 may correspond respectively to implementations of steps 614 and 602 as previously described with respect to FIG. 6. In some implementations, after the single combined probability model is generated, technique 900 may include storing the single combined probability model in a reference frame buffer corresponding to the reference frame from which the single combined probability model was generated. This may, for example, correspond to step 616 of FIG. 6. Subsequently, when processing the current frame, a decoder may decode an indication of which reference frame to obtain a single combined probability model from to use for the current frame. For example, the decoder may decode an indication to use the single combined probability model corresponding to the reference frame referenced above. This indication may be a syntax element within the bitstream that points to the specific reference frame buffer entry, such as described with respect to the initialization process at step 602 of FIG. 6. In such implementations, the step of initializing the respective probability model for the current tile using the single combined probability model as the initial probability model is performed responsive to the indication. This allows the encoder to select a single combined probability model from those available in the reference frame buffer which may enable the use of a single combined probability model best suited for the statistical distribution of values of syntax elements corresponding to the current frame.

For simplicity of explanation, the foregoing techniques are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a non-transitory computer-usable or computer-readable medium. A computer-usable or computer-readable medium can be any device that can, for example, tangibly contain, store, communicate, or transport a program including instructions for use by or in connection with any processor. For example, a processor may be configured to perform executed instructions stored in the memory (e.g., computer readable medium) to perform techniques embodied in the instructions. For example, a non-transitory computer-readable storage medium may include executable instructions that, when executed by a processor, facilitate performance of operations corresponding to techniques described in this disclosure. For example, a non-transitory computer-readable storage medium may store an encoded bitstream that is encodable or decodable using techniques described in this disclosure. The medium can be, for example, an electronic, magnetic, optical, electromagnetic, or semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method comprising:
generating a single combined probability model for a current frame based on a plurality of probability models including probability models respectively determined for each tile of a subset of tiles in a reference frame, the subset of tiles being fewer in number than a total number of tiles in the reference frame; and
for each current tile of a plurality of tiles of the current frame, initializing a respective probability model for the current tile using the single combined probability model as an initial probability model.

2. The method of claim 1, wherein the subset of tiles includes a maximum of 2, 4, or 6 tiles.

3. The method of claim 1, wherein generating the single combined probability model includes averaging the plurality of probability models.

4. The method of claim 1, wherein generating the single combined probability model includes weighted averaging the plurality of probability models.

5. The method of claim 4, wherein the probability models of the plurality of probability models each includes a set of probabilities for a syntax element and a count of updates to the set of probabilities and the weighted averaging of the plurality of probability models includes weighting based on the counts of updates to the sets of probabilities.

6. The method of claim 5, wherein the weighting based on the counts of updates to the sets of probabilities is capped at a weighting maximum.

7. The method of claim 1, further comprising:
storing the single combined probability model in a reference frame buffer; and
selecting the single combined probability model for initializing the probability model for the current frame based on an identification of the reference frame buffer.

8. The method of claim 7, wherein the reference frame buffer is saved in DRAM and the plurality of probability models are cached in SRAM.

9. The method of claim 1, further comprising:
selecting the subset of tiles from tiles in the reference frame based on side information decoded from a compressed bitstream.

10. The method of claim 1, further comprising:
selecting the subset of tiles according to a pre-determined process used by both encoder and decoder.

11. The method of claim 10, wherein a tile from the reference frame is included in the subset of tiles based on it having a largest tile size in the reference frame.

12. The method of claim 10, wherein a tile from the reference frame is included in the subset of tiles based on tile location.

13. The method of claim 1, wherein the subset of tiles is restricted to a pre-determined maximum number of tiles not based on a number of tiles in the reference frame.

14. The method of claim 1, wherein the plurality of tiles of the current frame includes a first current tile and a second current tile, the first current tile being co-located with a tile from the subset of tiles of the reference frame, and the second current tile not being co-located with any tile from the subset of tiles of the reference frame, and
wherein the single combined probability model is used to initialize the respective probability model for both the first tile and the second tile.

15. The method of claim 1, wherein the subset of tiles is selected to provide a spatially representative sample of the reference frame.

16. The method of claim 1, further comprising:
storing the single combined probability model in a reference frame buffer corresponding to the reference frame;
decoding an indication to use the single combined probability model corresponding to the reference frame,
wherein initializing the respective probability model for the current tile using the single combined probability model as the initial probability model is performed responsive to the indication.

17. A device for decoding a video stream, the device comprising:
a memory; and
a processor configured to execute instructions stored in the memory to:
generate a single combined probability model for a current frame based on a plurality of probability models including probability models respectively determined for each tile of a subset of tiles in a reference frame, the subset of tiles being fewer than a total number of tiles in the reference frame; and
for each current tile of a plurality of tiles of the current frame, initialize a respective probability model for the current tile using the single combined probability model as an initial probability model.

18. The device of claim 17, wherein the processor is configured to execute further instructions stored in the memory to select the subset of tiles from the reference frame based on a number of probability updates associated with each tile in the subset of tiles, wherein the single combined probability model is generated by performing a weighted average of the plurality of probability models based on counts of updates associated with each probability model of the plurality of probability models.

19. The device of claim 17, wherein the subset of tiles includes a pre-determined maximum number of tiles.

20. A non-transitory computer-readable storage medium having stored thereon an encoded video bitstream, wherein the encoded video bitstream is decodable by a decoder configured to:
generate a single combined probability model for a current frame based on a plurality of probability models including probability models respectively determined for each tile of a subset of tiles in a reference frame, the subset of tiles being fewer than a total number of tiles in the reference frame; and
for each current tile of a plurality of tiles of the current frame, initialize a respective probability model for the current tile using the single combined probability model as an initial probability model.
